(19) United States
(12) Patent Application Publication
(10) Pub. No.: US 2019/0064024 A1
(43) Pub. Date: Feb. 28, 2019

(54) WATER PRESSURE ALARM SYSTEM

(71) Applicant: STEVEN LINN WOLF, Lawrenceville, GA (US)

(72) Inventor: STEVEN LINN WOLF, Lawrenceville, GA (US)

(21) Appl. No.: 16/117,037

(22) Filed: Aug. 30, 2018

Related U.S. Application Data
(60) Provisional application No. 62/551,823, filed on Aug. 30, 2017.

(51) Int. Cl. G01L 19/12; G01L 19/08; G01L 19/16

(52) U.S. Cl. CPC G01L 19/12; G01L 19/083; G01L 19/16; G01L 19/086

(57) ABSTRACT

A water-pressure alarm device can include an inlet that receives water. It can also include a tube in fluid communication with the inlet that reacts based on the pressure of the water within the tube, a link mechanically coupled to the tube, and a movement mechanically coupled to the link. A conductive needle can be mechanically coupled to the movement, such that a reaction by the tube causes the link, movement, and needle to move accordingly. A first electrode is associated with the needle and a second electrode is mounted in a location that acts as a stop for the needle. The first and second electrodes are connected to an alarm that operates when the needle contacts the second electrode. The location of the second electrode can be chosen to correspond to a particular pressure level that would warrant an alarm, such as 100 psi.

### FIELD OF THE EMBODIMENTS

The embodiments herein relate generally to a water pressure alarm system and methods for using the same. More specifically, the embodiments relate to a water pressure sensor that can detect when water pressure exceeds a predetermined threshold and activate an alarm.

### BACKGROUND

Water is generally supplied to a building in one of two ways: (1) from a well located near the property, from which water is pumped, and (2) from a water-supply system operated by a government entity such as a city or county.

The water-supply systems operated by a city or county typically operate at high pressures to ensure that adequate water pressure is available to all buildings utilizing the water system. In a typical example, a water system can be maintained at around 200 psi.

The high pressure of a water system is far too high for the fixtures in a typical building to utilize properly. As a result, each building generally includes at least one pressure-reducing valve. A pressure-reducing valve can be any valve that receives fluid at one pressure level and expels fluid at a lower pressure level. In the case of a typical house, for example, the pressure-reducing valve can lower the pressuring of the incoming water from around 200 psi to around 50 psi. The lower pressure water can then be utilized by household fixtures such as water heaters, sinks, toilets, bathtubs, and so on.

In the case of a tall building, water is pumped to a location near the top of the building to be distributed down to the lower floors. Again, the water is stored at a pressure that allows all of the lower floors to have access to water at an acceptable pressure level. To maintain correct pressures for the lower floors, pressure-reducing valves are applied to each floor, or to groups of floors. For example, the building may have one pressure-reducing valve for every 10 floors.

Pressure-reducing valves have a lifespan of about 10-15 years. After that, they may stop functioning properly. Pressure-reducing valves fail by allowing full water flow—rather than no water flow—to ensure that water is available in case of an emergency. Therefore, a failed a pressure-reducing valve can supply high pressure water to a building, causing toilets to run, plumbing features to cease operating properly, and in some cases causing damage to plumbing components within the building. In these situations, no warning exists. Instead, the consequences of a failed pressure-reducing valve are the only indication of the failure.

A need therefore exists for a water-pressure gage that incorporates an alarm that can alert a user to a high-pressure state, allowing the user to take action and mitigate any negative consequences of a failed pressure-reducing valve.

### SUMMARY

Embodiments described herein include a water pressure alarm system and methods for using the same. In one embodiment, a water-pressure alarm device is provided. The device includes an inlet that receives water and a tube in fluid communication with the inlet. The tube can react based on the pressure of the water within the tube, such as by extending or otherwise changing its physical position. The device can also include a link mechanically coupled to the tube and a movement mechanically coupled to the link. A conductive needle can be mechanically coupled to the movement, such that a reaction by the tube causes the link, movement, and needle to move accordingly.

The water-pressure alarm device can also include a first electrode connected to the needle, and a second electrode mounted in a location that acts as a stop for the needle. The first and second electrodes are connected to an alarm that operates when the needle contacts the second electrode. The second electrode can be a post oriented orthogonally to the orientation of the needle, such that the post prevents the needle from continuing to move past the location of the post. The location can be chosen to correspond to a particular pressure level that would warrant an alarm, such as 100 psi. The alarm can produce a noise when engaged and can be coupled to a battery such that it does not need to be connected to a persistent power supply.

The alarm device can be installed on a water supply line, such as by connecting the device to one portion of a “T” connector. The alarm device can include a communication module that is configured to send a wireless transmission as a result of the needle contacting the second electrode. For example, the wireless transmission can be a notification sent to a mobile device, such as a smartphone, alerting the user of the alarm state.

Also disclosed is a system for detecting excessive water pressure. The system can include a water-pressure gage and an alarm. The water pressure gage can include an inlet that receives water and a tube, in fluid communication with the inlet, that reacts based on the pressure of the water within the tube. The gage can also include a link mechanically coupled to the tube, a movement mechanically coupled to the link, and a conductive needle mechanically coupled to the movement. Reaction by the tube causes the link, movement, and needle to move accordingly. The gage can further include a first electrode connected to the needle and a second electrode mounted in a location that acts as a stop for the needle.

The alarm can include a first connection to the first electrode and a second connection to the second electrode. When the needle contacts the second electrode, an electrical connection is established and the alarm is activated.

A method is also disclosed for activating an alarm indicating excessive water pressure. The method can include providing a water-pressure gage. The gage can include an inlet that receives water and a tube, in fluid communication with the inlet, that reacts based on the pressure of the water within the tube. The gage can also include a link mechanically coupled to the tube, a movement mechanically coupled to the link, and a conductive needle mechanically coupled to the movement. Reaction by the tube causes the link, movement, and needle to move accordingly. The gage can further include a first electrode connected to the needle and a second electrode mounted in a location that acts as a stop for the needle.

The method can also include providing an alarm that includes a first connection to the first electrode and a second connection to the second electrode. When the needle contacts the second electrode, an electrical connection is established.

The method can further include activating the alarm when the electrical connection is established.

Both the foregoing general description and the following detailed description are exemplary and explanatory only and are not intended to restrict the scope of the invention as claimed.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a diagram of an example water-pressure gage with electrodes.

FIG. 2 is a diagram of an example water-pressure alarm system.

FIG. 3 is a photograph of an alarm and an associated power supply.

FIG. 4 is a diagram of an example water-pressure alarm system implemented in a common residential setting.

### DETAILED DESCRIPTION

Reference will now be made in detail to the present exemplary embodiments, including examples illustrated in the accompanying drawings. Wherever possible, the same reference numbers will be used throughout the drawings to refer to the same or like parts.

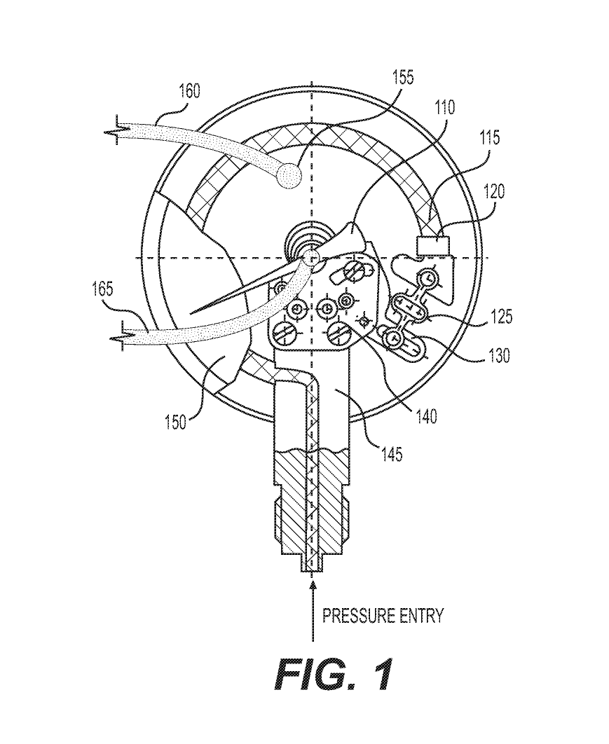

FIG. 1 provides a diagram of an example water-pressure gage with electrodes for use with an alarm as part of a water-pressure alarm system. The gage includes a needle 110 (also referred to as a pointer or indicator). The needle 110 can be used to determine a precise reading of the gage. In some examples, the needle 110 can indicate a pressure reading based on a dial 150 located in a viewport on the gage. For example, the gage can include a glass portion that allows a user to see the dial 150 and the needle 110 as it moves along the dial 150. However, neither the dial 150 nor a viewport is necessary.

The gage can include a stem 145 with a pressure connector that allows the gage to be connected to a pressurized water line. In one example, the gage is connected to a ⅜-inch fitting associated with a water line. The gage can be connected to a T-connector placed in line between two portions of a water line, for example. The stem 145 can include an inlet that receives water from the water line.

The inlet within the stem 145 can be connected to a tube 115. In one example, the tube 115 is a Bourdon tube. The tube 115 is in fluid communication with the inlet of the stem 145, such that the pressure in the main supply line is equal to the pressure in the inlet of the stem 145 and in the tube 115 as well. As the pressure of the supply line changes, the physical orientation of the tube 115 also changes. For example, as the tube 115 experiences more pressure, the tube 115 will attempt to straighten itself out from the orientation shown in FIG. 1. Various components in the gage are designed around this physical movement of the tube 115.

The tube 115 includes an end piece 120 that allows the tube 115 to be coupled to various other components. The end piece 120 can be made from any material, such as metal or plastic. The end piece 120 can be coupled to a link 125 as shown in FIG. 1. The link 125 is typically metal and is solidly attached to the end piece 120, such as by welding or mechanical coupling. When the pressure in the tube 115 increases, the tube 115 attempts to straighten itself out, pulling the link 125 with it and causing other components to move.

For example, the link 125 can be coupled directly to a movement 140, or to a quadrant 130 coupled to the movement 140. The quadrant 130 can be pivotably mounted to the stem 145 or another portion of the gage, such that movement of the link 125 causes the quadrant 130 to pivot about its mounting point. The quadrant 130, in turn, can be coupled to the movement 140. As the quadrant 130 rotates, the movement 140 is moved as well.

The movement 140 can be coupled to the needle 110, causing the needle 110 to rotate clockwise about the mounting point of the needle 110. The tube 115, link 125, quadrant 130, movement 140, and needle 110 can be calibrated such that the movement of the needle 110 corresponds to the pressure in the tube 115—and by extension, in the main water supply line.

As shown in FIG. 1, two wires 160, 165 can be connected to portions of the gage. In one example, the needle 110 is electrically conductive and can therefore function as an electrode. For example, the needle 110 can be made from a metallic material or can have a metallic coating, such as copper. Because the needle itself is conductive, a wire 165 can be connected to a portion of the needle 110 and conduct electricity.

The additional wire 160 can be connected an electrode 155 mounted in a strategic location. For example, the electrode 155 can be mounted in a location where the needle 110 will contact the electrode 155 if the needle 110 rotates a sufficient amount. The electrode 155 can be placed strategically such that the needle 110 contacts the electrode 115 at a particular threshold pressure. The threshold can be determined to be any pressure at which the alarm should sound. In one example, the threshold is about 100 psi. In other examples, however, the threshold can be any value that is 75 psi or above.

When the pressure in the main water supply line rises to the threshold value or above, the needle 110 will rise and contact the electrode 155. The contact between the needle 110 and the electrode 155 can close a switch or otherwise complete a circuit associated with the alarm. Even if the pressure rises above the threshold value, the needle 110 will be held against the electrode 155.

The electrode 155 can be a post, block, or other three-dimensional shape that blocks the path of the needle 110 at a designated location. In some examples, the electrode 155 is a copper post mounted to the gage.

Although a mechanical gage has been described above, the gage can also be digital. In that example, a threshold can be programmed into the gage such that at or above the designated threshold, the gage sends a signal via one or more wires 160, 165 to the alarm, indicating a high-pressure situation.

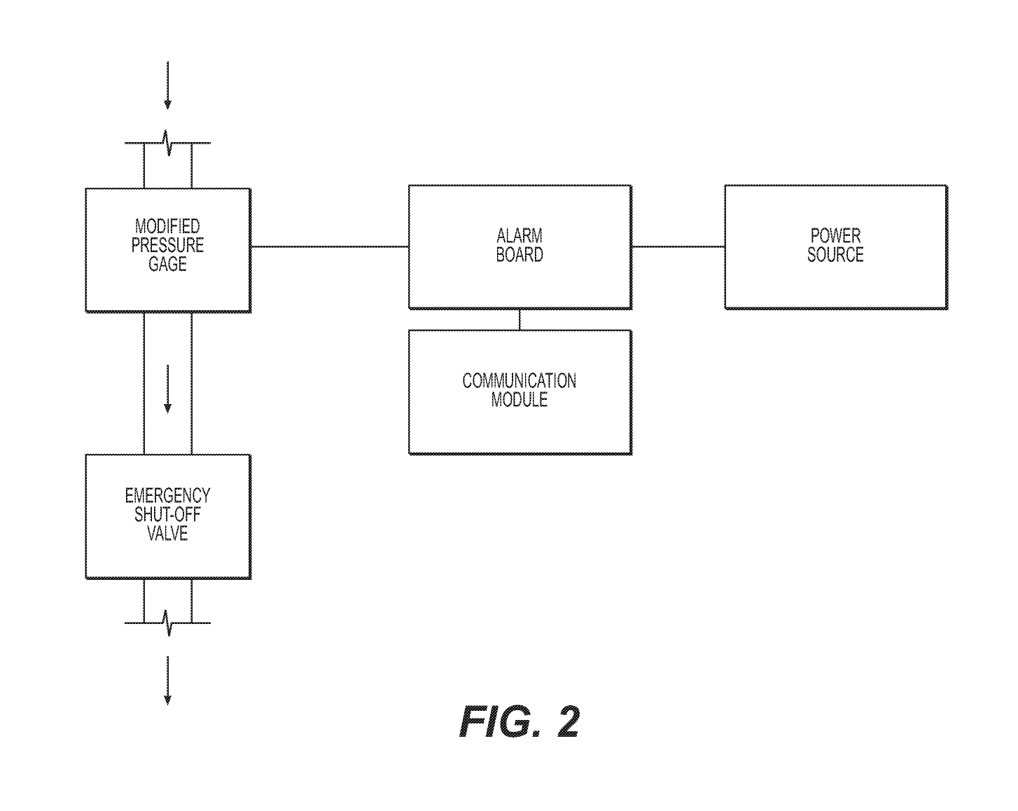

FIG. 2 provides a diagram of an example water-pressure alarm system. The system shows a main water supply line 210 with an indicated direction of flow. Along the supply line 210 is a modified pressure gage 220, such as the gage described with respect to FIG. 1, and an emergency shut-off valve 230. The emergency shut-off valve 230 can be a hand-operated valve such as the valves commonly installed with a toilet fixture.

Although FIG. 2 shows the pressure gage 220 installed upstream of the emergency shut-off valve 230, the pressure gage 220 can also be installed downstream of the valve 230. If installed upstream, in the case of a high-pressure situation, the gage 220 will continue to read the high pressure even after the shut-off valve 230 is closed. This can help to confirm that the pressure is at an acceptable level before opening the shut-off valve 230 again. If installed downstream, in the case of a high-pressure situation, the gage 220 will not detect any pressure after the shut-off valve 230 is closed. This can confirm that the pressure is not reaching the fixture (such as the toilet or faucet, for example). In some cases, it may be easier to install the gage 220 after the shut-off valve 230. The disclosure herein is equally applicable to both installation configurations.

The pressure gage 220 can be connected to an alarm board 240. For example, the pressure gage 220 can include wires 160, 165 that are electrically connected to the alarm board 240. When the needle 110 contacts the electrode 155 of FIG. 1, an electrical connection is made, completing the alarm circuit on the board 240. When the alarm circuit is closed, the alarm board 240 can take various actions in response.

In one example, the alarm board 240 can operate an audible alarm. The alarm can be loud enough for a person in the vicinity to hear. As an example, an alarm board 240 positioned in a master bathroom should be loud enough for someone in the master bedroom to hear. This allows the person to catch the problem sooner and take action, such as by operating the shut-off valve 230 and contacting a professional plumber.

The alarm board 240 can include a button that allows a user to manually turn off the alarm. For example, after a user takes corrective action during an alarm situation, such as by closing the shut-off valve 230, the user can press the button and stop the alarm from sounding. The alarm board 240 can also include one or more lights displaying colors corresponding to different operating states. For example, a green light can indicate proper operating pressures while a red light can indicate excessive pressure.

In one example, a green light can be illuminated at 20-second intervals to indicate a good battery. In the case of a low battery, the device can make a chirp or other sound in 10-minute intervals. For water pressure exceeding 100 psi, a chirping or other sound can be made at 5-second intervals.

The device can include an on/off toggle switch and can include a quick-connect ⅜th-inch female adaptor for portability and use with two different adapters. One adaptor can be a matching quick connect female ¾th-inch female connector for a hose or water heater boiler drain connection. The other adaptor can be a tee that allows connection to a sink or toiler between the emergency shut-off valve and its supply line connector. The quick connect feature allows for the battery to be changed easily without shutting off the water supply. Moreover, the device itself is portable and can be quickly and easily transported to different locations for wide-ranging use. In this context, “portable” can mean that the device can be connected and disconnected to a system without having to shut off a main water-supply line. Portable can also mean that the device is small enough such that it can easily be moved from on location to another. Portable can also mean that the device includes standard connections to make it easy to connect to any relevant system.

The alarm board 240 can be powered by a power source 250, such as a battery or an electrical outlet. The board 240 can also be hardwired to the building's electrical system, if desired.

The alarm board 240 can also be associated with a communication module 260. The communication module 260 can be located on the board 240 or can be a separate component electrically connected to the board 240. When excessive pressure is detected, the alarm board 240 can provide a signal to the communication module 260. That signal can cause the communication module 260 to transmit a communication regarding the pressure situation.

In one example, the communication module 260 includes a radio frequency (“RF”) transmitter. The RF transmitter can transmit a radio communication to a nearby receiver, such as cell phone associated with a user. In another example, the communication module 260 includes a WIFI transmitter that can transmit a wireless signal to a receiver, such as a cell phone. Other types of wireless transmitters can be used as well. In some examples, the signal transmitted by the communication module 260 can be incorporated into a home monitoring system, such as NEST.

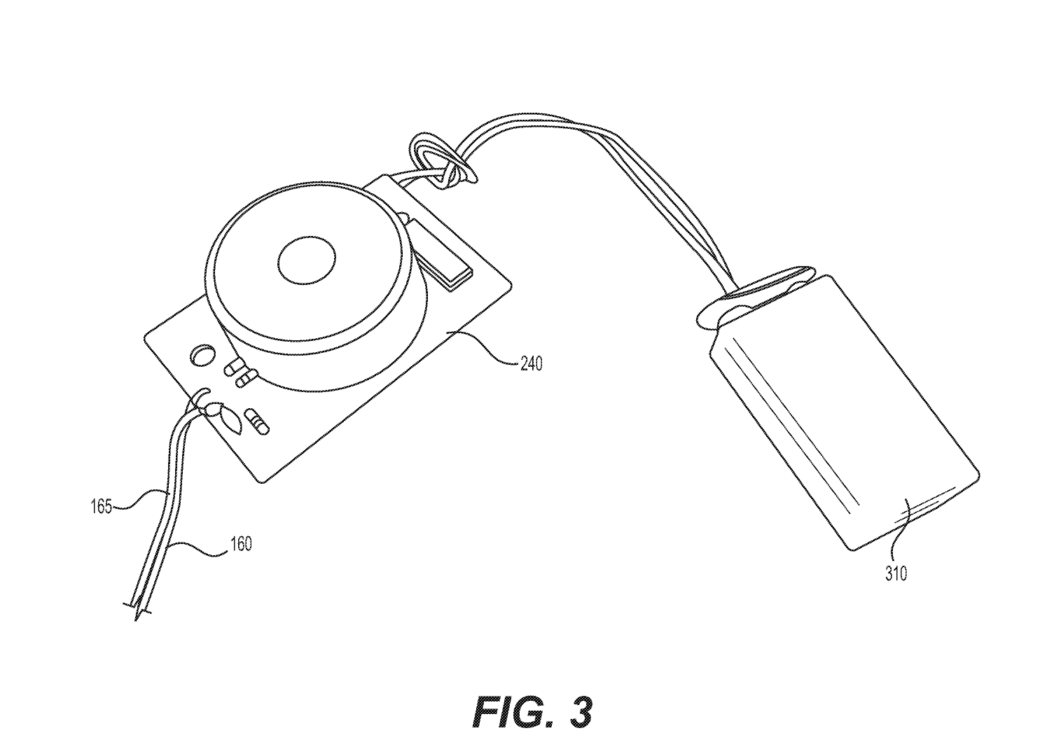

FIG. 3 provides a photograph of an alarm board 240 connected to a power supply 310. In this example, the power supply 310 is a 9-volt battery, but as explained above, any type of power supply can be used. Also shown are wires 160, 165 connected to the alarm board 240. The wires 160, 165 can be connected to a needle 110 and electrode 155, respectively, of a pressure gage 220. The alarm board 240 can be installed inside a housing that protects the components from moisture, dirt, and other elements.

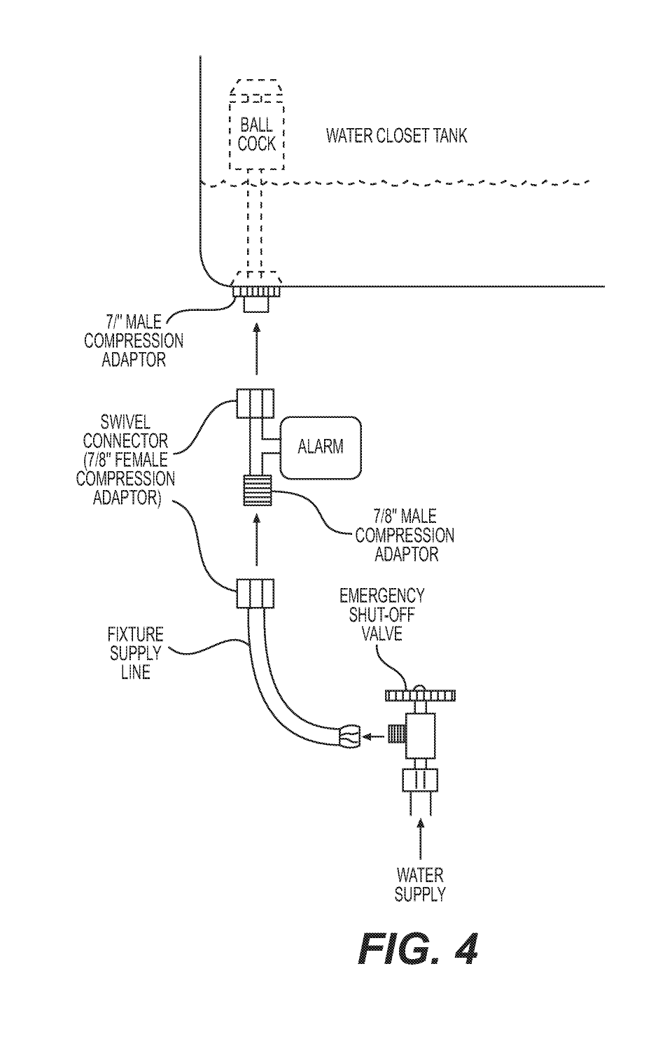

FIG. 4 provides a diagram of an example water-pressure alarm system implemented in a common residential setting. In this example, the alarm system is implemented at a toilet, such as the toilet in the master bedroom of a residence. The diagram includes a water supply line with an emergency shut-off valve that can be operated manually. The water supply travels through the shut-off valve and then through a fixture supply line, as with a typical toilet fixture.

Rather than attaching the fixture supply line directly to the toilet, it is instead connected to a t-connector. The t-connector can allow water to flow through the connector while also supplying the alarm. The “alarm” shown can include the pressure gage 220, alarm board 240, communication module 260, and/or power source 250 described with respect to FIG. 2. The t-connector can utilize a ⅞-inch compression adaptor fitting to connect to the supply line. It can also include a swivel connector having a ⅞-inch female compression adaptor. The swivel connector can be used to connect the t-connector to the water closer tank of the toilet.

Other configurations can be utilized as described above. However, the configuration of FIG. 4 provides a real-world example of a water-pressure alarm system that can be easily installed in a residence by a homeowner and provides meaningful feedback regarding the home's water pressure status.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

what is claimed is:

1. A water-pressure alarm device, comprising:
an inlet that receives water;
a tube, in fluid communication with the inlet, that reacts based on the pressure of the water within the tube;
a link mechanically coupled to the tube;
a movement mechanically coupled to the link;
a conductive needle mechanically coupled to the movement, wherein a reaction by the tube causes the link, movement, and needle to move accordingly;
a first electrode associated with the needle; and
a second electrode mounted in a location that acts as a stop for the needle,
wherein the first and second electrodes are connected to an alarm that operates when the needle contacts the second electrode.

2. The water-pressure alarm device of claim 1, wherein the second electrode is a post oriented orthogonally to the orientation of the needle.

3. The water-pressure alarm device of claim 1, wherein the location of the second electrode corresponds to a water pressure of about 100 psi.

4. The water-pressure alarm device of claim 1, wherein the alarm is coupled to a battery.

5. The water-pressure alarm device of claim 1, wherein the alarm device is configured to be positioned on a water supply line.

6. The water-pressure alarm device of claim 1, wherein the alarm comprises a communication module configured to send a wireless transmission as a result of the needle contacting the second electrode.

7. The water-pressure alarm device of claim 6, wherein the wireless transmission is sent to a mobile device of a user, alerting the user of the alarm state.

8. A system for detecting excessive water pressure, comprising:
a water-pressure gage comprising:
an inlet that receives water;
a tube, in fluid communication with the inlet, that reacts based on the pressure of the water within the tube;
a link mechanically coupled to the tube;
a movement mechanically coupled to the link;
a conductive needle mechanically coupled to the movement, wherein a reaction by the tube causes the link, movement, and needle to move accordingly;
a first electrode associated with the needle; and
a second electrode mounted in a location that acts as a stop for the needle;
an alarm comprising:
a first connection to the first electrode; and
a second connection to the second electrode,
wherein when the needle contacts the second electrode, an electrical connection is established that activates the alarm.

9. The system of claim 8, wherein the second electrode is a post oriented orthogonally to the orientation of the needle.

10. The system of claim 8, wherein the location of the second electrode corresponds to a water pressure of about 100 psi.

11. The system of claim 8, wherein the alarm is coupled to a battery.

12. The system of claim 8, wherein the water-pressure gage is configured to be positioned on a water supply line.

13. The system of claim 8, wherein the alarm further comprises a communication module configured to send a wireless transmission as a result of the needle contacting the second electrode.

14. The system of claim 13, wherein the wireless transmission is sent to a mobile device of a user, alerting the user of the alarm state.

15. A method for activating an alarm indicating excessive water pressure, comprising:
providing a water-pressure gage comprising:
an inlet that receives water;
a tube, in fluid communication with the inlet, that reacts based on the pressure of the water within the tube;
a link mechanically coupled to the tube;
a movement mechanically coupled to the link;
a conductive needle mechanically coupled to the movement, wherein a reaction by the tube causes the link, movement, and needle to move accordingly;
a first electrode associated with the needle; and
a second electrode mounted in a location that acts as a stop for the needle;
providing an alarm comprising:
a first connection to the first electrode; and
a second connection to the second electrode,
wherein when the needle contacts the second electrode, an electrical connection is established; and
activating the alarm when the electrical connection is established.

16. The method of claim 15, wherein the second electrode is a post oriented orthogonally to the orientation of the needle.

17. The method of claim 15, wherein the location of the second electrode corresponds to a water pressure of about 100 psi.

18. The method of claim 15, wherein the alarm is coupled to a battery.

19. The method of claim 15, wherein the alarm further comprises a communication module configured to send a wireless transmission as a result of the needle contacting the second electrode.

20. The method of claim 15, wherein the wireless transmission is sent to a mobile device of a user, alerting the user of the alarm state.
